(19) United States
(12) Patent Application Publication
(10) Pub. No.: US 2010/0282126 A1
(43) Pub. Date: Nov. 11, 2010

(54) SURFACTANT-TREATED CELLULOSE FIBERS FOR USE IN ASPHALT COMPOSITIONS

(75) Inventor: James E. Nevin, Lakeworth, FL (US)

Correspondence Address: RENNER KENNER GREIVE BOBAK TAYLOR & WEBER, FIRST NATIONAL TOWER, SUITE 400, 106 SOUTH MAIN STREET, AKRON, OH, 44308-1412, US

(73) Assignee: Momentum Technologies, Inc.

(21) Appl. No.: 12/435,824

(22) Filed: May 5, 2009

(51) Int. Cl. C09D 195/00; C09D 101/00

(52) U.S. Cl. 106/164.6; 106/501.1

(57) ABSTRACT

Cellulose fibers are treated with a surfactant package to improve their use in the formation of viscosity enhancing gel structures in asphalt compositions. In a particular embodiment, the cellulose fibers are obtained from recycling magazines, newspapers and similar such materials, and are used in asphalt compositions that incorporate the use of other viscosity modifiers, such as mineral aggregates and fillers like attapulgite clay. The use of surfactant-treated cellulose fibers improves the formation, strength and durability of the gel structure and reduces the number of manufacturing steps normally required in the process for producing the asphalt compositions. Use of these fibers can eliminate or reduce the need to maintain and handle stocks of potentially harmful and corrosive liquid surfactants.

### FIELD OF THE INVENTION

This invention relates asphalt compositions and fibers employed in such compositions. More particularly, this invention relates to the manufacture and of surfactant-treated cellulose fibers, and, in particular embodiments, relates to the use of such fibers in asphalt compositions.

### BACKGROUND OF THE INVENTION

For some time, asbestos fibers were used in asphalt compositions other organic coating materials for roofing applications, automotive underbody coatings, foundation coatings, mastics and adhesives, and other specialty applications. The asbestos served to provide a thixotropic structure that was sag resistant and did not settle in storage. However, in light of environmental and other safety concerns respecting asbestos, entrepreneurs in relevant industries developed alternative gelling and viscosifying agents. Of these, asphalt clay minerals, and particularly attapulgite clay minerals, were shown to be suitably effective and are now widely used. It is common to employ cellulose fibers along with these clays, because the fibers impart not only additional thixotropy but also a fibrated texture similar to that found historically in asbestos. The cellulose fibers function as fillers or viscosity modifiers to impart structural properties to the end product.

Attapulgite and other clays such as bentonite and kaolinite are employed to achieve the gelling properties previously provided by the now disfavored asbestos, but, because of interfacial tension between these asphalt clays and the asphalt, it is necessary to employ surfactants to facilitate the dispersion of the clay. Thus, a liquid surfactant is typically added to the asphalt before addition of the clay. As the clay is added and the mix is mechanically agitated, a gel structure begins to form as the hydrophilic portion of the surfactant molecule associates with the clay and suspends it. Without the presence of the surfactant, the hydrophilic surface of the clay naturally repels the asphalt and will not form a durable suspension. This formula is the basic building block of a variety of compositions referred to as asphalt cements and coatings. Attapuligite clay is perhaps the most desirable and widely used asphalt clay. By “asphalt clay” it is meant any clay that thickens the asphalt composition and provides viscosity enhancing properties or gelling properties or both.

In a particularly large industrial application involving roofing products, cellulose fibers are used in conjunction with asphalt cutback, attapulgite clay and a surfactant package to produce fibrated, asbestos-free roofing cements and coatings.

In these products, an example of which is taught in Vicenzi U.S. Pat. No. 4,759,799, the addition of ingredients must follow a very specific procedure. First, the surfactant package is added and thoroughly mixed with the asphalt cutback. The attapulgite clay is then added and the mix is mechanically agitated to disperse the clay. Cellulose fibers and other fillers are then added. However, a gel structure begins to form after the clay is added, and this can frustrate fiber dispersion. Particularly, by the time the fibers are added, a gel structure has begun to form, and the viscosity has built to the point where it is difficult to disperse the tightly bound cellulose fiber bundles with mixing equipment and techniques currently used in the industry. Thus, there exists a need in the art for a process for creating cellulose fiber-containing asphalt cements and coatings wherein the dispersion of the cellulose fibers is improved. Additionally, because process efficiency is often related to the number of process steps, the production of asphalt cements and coatings may further be improved by developing products and processes that eliminate the separate surfactant addition step from the general process outlined above.

Notably, the industrial liquid surfactants employed in asphalt cements and coatings are considered a skin or body tissue irritant and are labeled as corrosive. As a result, these surfactants must be stored and handled with special care in order to prevent serious physical danger to the handlers and production workers. Because the surfactant package must be added before the clay, the surfactant is typically stored at or transported to the factory or other worksite where the desired asphalt cement or coating product is being produced. Transporting and storing corrosive surfactant decreases safety and increases costs. It would therefore be advantageous to eliminate the need for a separate liquid surfactant inventory at such worksites.

The shipping and storage of the cellulose fibers can also complicate the process of producing asphalt cements and coatings. Cellulose fibers are often pressure or vacuum packaged for shipment and storage, and, as a result of the compressive forces inherent in such packaging, the individual fibers tend to clump together. When poured from these packages into an asphalt mixture, many of the fibers are trapped in tight fiber bundles that are difficult to break up even under significant agitation. Either additional process steps must be employed to break up these bundles (before or after their introduction into the asphalt mix) or the decreased dispersion resulting from the bundles must be accepted. The art would therefore benefit from the provision of cellulose fibers that resist forming such fiber bundles.

Frizzel U.S. Pat. No. 4,738,723 discloses the use of water borne agents as release agents or dispersing agents for cellulose fibers, improving their performance in asbestos free asphalt cement applications. The water borne agents can include acrylic latexes, asphalt emulsions or aqueous surfactant solutions. The patent is silent on benefits respecting the enhancement of secondary gelling systems.

Thermoguard Insulation Company (Billings, Mont., USA) advertises the manufacture and sale of cellulose products containing a variety of chemical surface treatments designed to protect against fire, insects and decay. Thermoguard manufactures its cellulose products by deconstructing recycled paper products using a process that includes the use of a Fiberizer that produces a more porous fiber having better insulating properties compared with fibers made from hammer mills. The chemical surface treatments do not include surfactants chosen to facilitate dispersion of attapulgite clay.

It is believed that no reference is to be found to the preparation of surfactant-treated cellulose fibers for the purposes of improving the viscosity and durability of attapulgite clay-enhanced gel structures while eliminating the separate addition of a corrosive liquid surfactant.

### SUMMARY OF THE INVENTION

In light of the foregoing, cellulose fibers are treated with a surfactant package to produce surfactant-treated cellulose fibers that can be employed to overcome the problems associated with the production of asphalt cement and coating formulations as outlined above. The surfactant-treated cellulose fibers resist agglomeration and thus are more readily dispersed in asphalt or asphalt cutback. Because they include surfactant, they can be added before the addition of viscosity-building asphalt clays, and this further facilitates the dispersion of the cellulose fibers since they are added and mixed before the clay addition causes the asphalt mix to begin to gel. The improved dispersion leads to an unexpected improvement in the properties of the final asphalt end products produced. Indeed, it has unexpectedly been found that the surfactant-treated cellulose fibers of this invention can be used in certain asphalt compositions so as to eliminate the need for asphalt clay additions, as will be described more particularly herein. In such compositions, the addition of inert fillers, such as finely ground limestone and diatomaceous earth can be employed to provide an asphalt composition with desired end properties, without the addition of clays that interact with the asphalt and the surfactant. Finally, by providing the surfactant as a surface treatment on the cellulose fibers, corrosive and hazardous liquid surfactant need not be stored or shipped to a worksite.

In accordance with an embodiment of this invention, surfactant-treated cellulose fibers are provided. These surfactant-treated cellulose fibers include cellulose fibers and a clay surfactant incorporated into or on said cellulose fibers, wherein said clay surfactant is a surfactant that reduces the interfacial tension between asphalt clay minerals and asphalt. This invention also provides asphalt compositions that include the surfactant-treated cellulose fibers as just described. By “asphalt clay” it is meant any clay that thickens the asphalt composition and provides viscosity enhancing properties or gelling properties or both.

In accordance with another embodiment, a method is provided for producing an asphalt composition. Surfactant-treated cellulose fibers are added to asphalt, wherein the surfactant-treated cellulose fibers include: cellulose fibers, and a clay surfactant incorporated into or on said cellulose fibers or both. The clay surfactant is a surfactant that reduces the interfacial tension between asphalt clay minerals and asphalt. After the addition of the surfactant-treated cellulose fibers, an asphalt composition addition is added, the asphalt composition being selected from inert filler and asphalt clay.

### DETAILED DESCRIPTION OF THE INVENTION

The surfactant-treated cellulose fibers of this invention have the appearance and texture of non-treated cellulose fibers, but, due to the surface treatment, they contain the active chemical components necessary to enhance the formation of clay gel structures in asphalt compositions. Additionally, the surface treatment does not appear to adversely affect the natural viscosity and texture enhancing features associated with the historic use of such fibers. The presence of the surfactant also significantly prevents the agglomeration of fiber bundles that typically results from compressive forces employed in pressure or vacuum packaging fibers. With less agglomeration, the fibers can be dispersed into a base material with minimal agitation, without employing expensive processing aids such as bundle shredders. This also makes maximum use of the surface area effect associated with the use of the fibers.

The cellulose fibers may be obtained from virtually any source, though, in accordance with particular embodiments, the cellulose fibers are derived from the processing of waste streams of newspapers, magazines and other fibrous products, to advantageously recycle such waste products. These products are readily deconstructed using Hammer Mills, Fiberizers and similar equipment designed to shred, pulverize and expand the recycled materials. Several companies including Interfibe Corporation (Solon, Ohio, USA), CreaFill Fibers Corp (Baltimore, Md., USA) and Central Fiber Corporation (Wellsville, Kans., USA) produce such cellulose fiber products. Of course, companies such as Weyerhaeuser Company (Federal Way, Wash., USA) produce cellulose fibers from virgin wood pulp, and such virgin cellulose fibers are suitable for this invention.

The cellulose fibers included in this invention can be produced by the deconstructive processing of newspapers, magazines and similar paper products that have been set aside for recycling purposes. This will beneficially reduce waste that would otherwise go to a land fill or be burned. There is a virtual unlimited supply of magazines, newspapers and other such paper products from which to create the composition of this invention; however, they can also be produced from any number of processes that originate with the formation of wood pulp such as the manufacture of virgin paper products. They can be produced in any number of shapes and sizes, textures and densities; from a fine particulate form less than 1 mm in length and width to being several cm in length. The methods of production of these fibers create a surface area that is extremely large as compared to the mass of the fibers.

Functional adjuvants can be deposited on these fibers, and their presence can significantly enhance the fibers' natural functions. As known in the art, these adjuvants may include pluronic surfactanct that are used as processing and/or release aids. Such adjuvants would be employed in typical amounts already practiced in the art.

Cellulose fibers are distinguishable from finely divided, high surface area cellulose products such as carboxymethyl cellulose, hydroxyethyl cellulose and other similar products in that they have a fibrous appearance which imparts texture in addition to viscosity to a liquid or pasty product. Also, because of their structural enhancement properties, they can be used in applications that are not water borne, where finely dispersed cellulose products are ineffective due to their lipophobic chemical nature.

The surfactants used to treat cellulose fibers in accordance with this invention are chosen from what are defined herein as “clay surfactants.” As used herein “clay surfactants” are surfactants that function to reduce the interfacial tension between asphalt clay and asphalt, and increase the viscosity and/or gel strength of asphalt compositions containing clays. By “asphalt clay” it is meant that the clay actually chemically interacts with the fiber and asphalt to enhance viscosity. Useful clay surfactants can be readily determined whether they are now know or hereinafter discovered. The clay surfactant can also include mixtures of suitable surfactants. Thus, the clay surfactant may be referred to as a clay surfactant package, which is to be understood to encompass either a single clay surfactant or a mixture of clay surfactants.

In particular embodiments, the clay surfactants are cationic surfactants chosen according to their ability to increase the viscosity and/or gel strength of asphalt compositions containing clay, and, as such, useful cationic surfactants can be readily determined whether they are now know or hereinafter discovered. Useful cationic surfactants may be selected from fatty amines and the organic and mineral acid salts thereof; alkyloxyalkylamines and the organic and mineral acid salts thereof; and quaternary ammonium compounds. Mixtures of the foregoing may also be employed. Included surfactants may be mono-functional or multi-functional and may be fully or partially neutralized or used neat.

Particularly useful quaternary ammonium salts include dicocodimethyl ammonium chloride, tallow trimethyl ammonium chloride, and methyl-1-oleylamidoethyl-2-oleylimidazolinium methyl sulfate. Quaternary ammonium chloride salts are typically in a solid or paste-like form at room temperature thereby making it difficult to admix the surfactant with the other coating constituents and to obtain a homogenous mixture. In order to utilize these types of surfactants, they typically must first be liquified, either by admixture with solvents or by heating the surfactants.

Particularly useful alkyloxyalkylamines include isodecyloxypropyl amine acetates, such as those described in U.S. Pat. No.4759799.

Particularly useful are organic salts of fatty diamines. In particular embodiments, these include organic salts of polyamine and a carboxylic acid such as those described in U.S. Pat. No.5,529,621.

Particularly preferred clay surfactants are water-soluble or partially water soluble. Such particularly preferred surfactants are the neoacid salts of tallow diamines.

The cellulose fibers can be treated with the clay surfactant package through a number of methods. In one process, the clay surfactant package is simply added in a liquid form to a bulk supply of cellulose fibers and mixed to ensure that the individual fibers are coated and/or impregnated with the clay surfactant package. Any excess liquid surfactant is drained, and the mixture is permitted to dry, leaving behind a bulk supply of cellulose fibers treated with clay surfactant. As discussed more fully below, this addition of the clay surfactant package can beneficially take place during the actual formation of the cellulose fibers in a deconstruction of waste products or virgin products containing cellulose.

In another process, the fibers are spray coated with the clay surfactant package in liquid form and permitted to dry.

Because the clay surfactants seem to be quickly released upon dispersion into the asphalt, it is currently believed that the surfactant molecules are adsorbed onto the surface of the cellulose fibers. However, it is also hypothesized that the hydroxyl moieties of the cellulose could interact with the positive charge of the nitrogen containing salt molecules via their electronic attraction. This, along with the lipophilic tail of the surfactant molecule, could explain the improved dispersion of the fibers into the asphalt as compared to fibers not treated in accordance with this invention. Whether impregnated or surface coated, the surfactant-treated fibers improve the resultant asphalt cement and coating formulations in which they are employed.

During the process of deconstructing waste products or virgin products containing cellulose, a lubricant or cooling agent is often used to reduce the buildup of heat due to friction, for example, from shredding and grinding phases. The customary lubricant is water because it is effective, readily available, inexpensive and readily removed upon completion of the process. The use of water soluble clay surfactants of the present invention is particularly beneficial because those surfactants can be added to the lubricating water employed in the deconstruction process thereby eliminating the need for an additional manufacturing step to surface coat the fiber. These surfactants can significantly enhance the cooling effects of the water by offering superior lubricating properties compared to water alone. They can also impart corrosion inhibition properties to the process by virtue of their specific functional chemical attributes. The water soluble clay surfactant package containing water solution can be added at any step in the deconstruction process, and, in the case of virgin production of paper, can be added in the pulp or paper formation or subsequent deconstruction process thereof.

In particular embodiments, the surfactant-treated cellulose fibers are made up of from 65 to 90% cellulose fiber and from 10 to 35% of a clay surfactant by weight.

The surfactant-treated cellulose fibers of this invention advantageously resist clumping together during storage and shipping. That is, even when subject to high pressure or vacuum packaging, the individual fibers will more readily release from a compressed bulk mass of fibers when the containment film is removed and the bulk mass of fibers is subject to minimal agitation. This is an advantage over the prior art non-treated fibers, which tended to remain clumped together despite significant agitation experienced during the mixing of the bulk mass into an asphalt coating composition. Such compositions are more specifically addressed below.

The surfactant-treated cellulose fibers of this invention also advantageously suppress dust that is associated with the product during production, packaging and use. The dust is a result of loose fine fibers and kaolin clay contained in the previous packaging, particularly when using magazines as the deconstruction feedstock.

The surfactant-treated cellulose fibers can be advantageously employed in asphalt compositions. In particular embodiments, the surfactant-treated cellulose fibers are dispersed in asphalt or asphalt cutback along with clay minerals to create asphalt cement or asphalt coating formulations. These asphalt-based compositions will include (a) asphalt, (b) surfactant-treated cellulose fibers in accordance with this invention, (c) asphalt clay minerals and, optionally, (d) additional fillers as known in the art.

The asphalt may be provided as bulk asphalt or as asphalt cutback or asphalt emulsion. An asphalt emulsion is a suspension of small asphalt cement globules in water, which is assisted by an emulsifying agent (such as soap). Emulsions have lower viscosities than neat (plain) asphalt and can thus be used in low temperature applications. After an emulsion is applied the water evaporates away and only the asphalt cement is left in the ultimate end product. An asphalt cutback is a combination of asphalt cement and petroleum solvent. Like emulsions, cutbacks are used because their viscosity is lower than that of neat asphalt and can thus be used in low temperature applications. After a cutback is applied the solvent evaporates away and only the asphalt cement is left.

In particular embodiments, the asphalt compositions include from 40 to 65% by weight of asphalt. In other embodiments, the asphalt compositions include from 50 to 60% by weight asphalt, and, in yet other embodiments, from 55 to 58% by weight.

A variety of asphalt clay can be used in this invention. Preferred clays are of the attapulgite type, which are mined from deposits in the vicinity of Attapulgus, Ga., USA. These clays are specifically sized after the mining process to provide a small uniform particle size with a large surface area, which maximizes their efficacy to provide improved viscosity and/or thixotropy. Other clays such as the bentonite type may also be used with good results. Sepiolites may also be used. Kaolinites are also suitable.

Examples of suitable asphalt clays include Attagel 20, Attagel 36, and Attagel 40, which are attapulgite clays available from BASF Corporation; Min-U-Gel AR, Min-U-Gel PC, and Min-U-Gel FG, which are attapulgite clays available from Active Minerals International LLC (Hunt Valley, Md., USA); Gel 601P, which is an attapulgite clay available from BASF Corporation; and Pangel FF which is a sepiolite clay from Tolsa S. A. (Madrid, Spain).

In particular embodiments, the weight ratio of asphalt to clay is from 4:1 to 12:1, in other embodiments, from 7:1 to 10:1, and, in yet other embodiments, from 8:1 to 9:1.

Suitable surfactant-treated cellulose fibers have been described in detail above. In particular embodiments, these surfactant-treated cellulose fibers are added in an amount sufficient to achieve an asphalt clay to surfactant ratio (C/S ratio) of from 4:1 to 14:1. In other embodiments, the surfactant-treated cellulose fibers are added in an amount sufficient to achieve a C/S ratio of from 6:1 to 12:1, and, in yet other embodiments, from 8:1 to 10:1. Thus, the amount of surfactant-treated cellulose fiber added will depend upon the amount of surfactant loaded onto the cellulose fibers. If surfactant-treated fibers in accordance with this invention are added and, due to the amount of surfactant loaded on the fibers, a desired C/S ratio is met before the addition of a desired amount of fiber, non-treated fibers may be added to reach a desired fiber loading.

In particular embodiments, the asphalt compositions include from 1 to 10% by weight surfactant-treated cellulose fibers, in other embodiments, from 2 to 8% by weight, and, in yet other embodiments, from 4 to 6% by weight. As already mentioned, a desired C/S ratio may be achieved by the addition of less than the desired amount of surfactant-treated fibers, and non-treated fibers can be added to reach the desired fiber loading.

In accordance with particular embodiments, an asphalt composition in accordance with this invention includes from 40 to 60 wt % asphalt, from 4 to 12 wt % asphalt clay, from 2 to 6 wt % of recycled cellulose fibers treated in accordance with this invention, and from 2 to 30 wt % of additional fillers. In more particular embodiments, the surfactant package with which the fibers are treated is selected from organic acid salts of mono and multi functional ether and fatty amines.

This invention also provides a process for producing an asphalt composition including asphalt or asphalt cutback, cellulose fibers, and asphalt clay. In accordance with this process, the cellulose fibers are treated with a clay surfactant package in accordance with the guidance provided above respecting surfactant-treated cellulose fibers of this invention. These surfactant-treated cellulose fibers are added to asphalt or asphalt cutback and mixed. After this mixing step, the asphalt clay is added with further mixing. Optionally, mineral fillers and/or additional asphalt or asphalt cutback can be added after the additions of surfactant-treated cellulose fibers and asphalt clay to achieve the final desired product consistency depending on the end use.

It has unexpectedly been found that the surfactant-treated fibers can also be used in certain asphalt compositions so as to eliminate the need for asphalt clay additions. In these compositions the addition of inert fillers such as finely ground limestone and diatomaceous earth can be employed to provide an asphalt composition with desired end properties.

Thus, it has been surprisingly found that the surfactant-treated cellulose fibers can be advantageously employed in asphalt compositions devoid of typical asphalt clays, as defined herein. In particular embodiments, the surfactant-treated cellulose fibers are dispersed in asphalt or asphalt cutback along with typical inert fillers to create asphalt cement or asphalt coating formulations having desired properties. These asphalt-based compositions will include (a) asphalt, (b) surfactant-treated cellulose fibers in accordance with this invention, and (c) inert fillers. These inert fillers are well known in the art and, by way of non-limiting example, can be selected from limestone, diatomaceous earth, talc, mica, and mixtures of the forgoing.

In particular embodiments devoid of asphalt clay, the asphalt compositions include from 2 to 65% by weight of asphalt. In other embodiments, the asphalt compositions include from 4 to 60% by weight asphalt, and, in yet other embodiments, from 5 to 58% by weight. These asphalt compositions further include from 1 to 10% surfactant-treated cellulose fibers in accordance with this invention. In other embodiments, the asphalt compositions further include from 2 to 8% by weight surfactant-treated cellulose fibers, and, in yet other embodiments, from 3 to 6% by weight. The inert fillers and/or aggregates are present at from 2 to 96% by weight. In other embodiments, the asphalt compositions further include from 5 to 92% by weight inert filler, and, in yet other embodiments, from 10 to 88% by weight

The use of the surfactant-treated cellulose fibers of this invention yields a number of advantages. First, the fact that the surfactant package is incorporated into the cellulose fibers eliminates the need for transporting, storing and handling a separate corrosive liquid surfactant inventory at a worksite. Instead, only the surfactant-treated fibers need to be transported, stored and handled. Second, the surfactant-treated cellulose fibers will more readily release from a vacuum or pressure package, wherein the fibers normally tend to clump together, making it difficult to disperse them throughout the asphalt or asphalt cutback. Third, the because the surfactant is included in the fibers, the fibers are added prior to the clay, and thus prior to the formation of a gel structure that might frustrate the ability to disperse tightly bound cellulose fiber bundles with mixing equipment and techniques currently used in the industry. Also, because the surfactant-treated cellulose fibers are added prior to the clay and include the surfactant package necessary to reduce the interfacial tension between the clay and the asphalt, the clay will be more readily suspended and dispersed in the asphalt without falling to the bottom or otherwise agglomerating together. This benefit will be particularly realized when the clay is being added to hot asphalt, which has a lower viscosity and thus less tendency to suspend the clay against gravity or other forces. In some instance, these fibers might also permit the creation of suitable asphalt compositions devoid of the typical asphalt clay additions.

### Experimental

The following examples will further illustrate the preparation of the asbestos-free asphalt composition according to the present invention. They are given by way of illustration and not as limitations on the scope of the invention. Thus, it should be understood that reactants, proportions of reactants, and time and temperature of the reaction steps may be varied with much the same results achieved.

### EXAMPLE 1

An attapulgite clay surfactant composition is prepared by reacting 21 grams of acetic acid with 79 grams of isodecyloxypropyl amine to form the acetate salt of the ether amine. The resultant salt surfactant is a pourable liquid at 77 degrees Fahrenheit.

### EXAMPLE 2

An attapulgite clay surfactant composition is prepared by reacting 56 grams of N-tallow-1,3-propylenediamine having an average combing weight of 165, with 44 grams of Neoheptanoic acid to form the Neoheptanoate salt of the fatty diamine. The resultant salt surfactant is a pourable liquid at 77 degrees Fahrenheit.

### EXAMPLE 3

Weigh out 10.30 grams of GC-66 cellulose fibers (Interfibe Corporation, Ohio, USA) and add to an 8″ diameter stainless steel bowl. To the cellulose fibers, spray by fine air atomization 11.84 grams total of a surfactant package comprised of 2.81 grams (8.19%) of the surfactant preparation from Example 1, 10.03 (29.21%) grams of the surfactant preparation from Example 2, and 21.49 grams (62.60%) of water. The surfactant solution is applied intermittently to the fibers in between a tossing and mixing of the fibers so as to evenly disperse it over the surface area of the fibers. Total active surfactant added to the fibers is 4.42 grams. The damp fibers are kept in the bowl with occasional tossing in order to evaporate most of the water from the fiber surface.

### EXAMPLE 4

Weigh out 10.30 grams of GC-66 cellulose fibers (Interfibe Corporation) and add to an 8″ diameter stainless steel bowl. To the cellulose fibers, spray by fine air atomization 6.0 grams of a surfactant package comprised of 10.6 grams (59.75%) of the surfactant preparation of Example 2, and 7.14 grams (40.25%) of water. The surfactant solution is applied intermittently to the fibers in between a tossing and mixing of the fibers so as to evenly disperse is over the surface area of the fibers. The damp fibers are kept in the bowl with occasional tossing in order to evaporate most of the water from the fiber surface.

### EXAMPLE 5

Weigh out 199 grams of asphalt cutback (70% asphalt, 30% solvent) obtained from The Brewer Company (Ohio, USA) preheated to 130 degrees Fahrenheit into an 8″ diameter mixing bowl from a common countertop chefs blender (KITCHEN AID™ brand employed). To the cutback add the surfactant-treated fibers from Example 3 and stir at #2 speed of the blender for 5 minutes using a flat beater attachment. The fibers disperse rapidly into the cutback forming a flowable fibrated asphalt composition. After 5 minutes of mixing, add 30.0 grams of Min-U-Gel G-35 Attapulgite Clay (Active Minerals International), and continue mixing for a further 10 minutes. Add a further 55 grams of asphalt cutback followed by 5 minutes of mixing to complete the batch. The resultant mixture quickly developed into a non-flowable thixotropic asphalt mastic.

### EXAMPLE 6

Weigh out 198 grams of asphalt cutback obtained from The Brewer Company preheated to 130 degrees Fahrenheit into an 8″ diameter mixing bowl from a common countertop chefs blender (KITCHEN AID™ brand employed). To the cutback add 14.21 grams of the surfactant treated GC-66 fibers from Example 4 and stir at #2 speed for 5 minutes using the flat beater attachment. The fibers disperse rapidly into the cutback forming a flowable fibrated asphalt composition. After 5 minutes of mixing, add 30.0 grams of Min-U-Gel G-35 Attapulgite Clay (Active Minerals) and continue mixing for a further 10 minutes. Add a further 55 grams of asphalt cutback followed by 5 minutes of mixing to complete the batch. The resultant mixture quickly developed into non-flowable thixotropic asphalt mastic.

### EXAMPLE 7

Weigh out 200 grams of asphalt cutback obtained from The Brewer Company preheated to 130 degrees Fahrenheit into an 8″ diameter mixing bowl from a common countertop chefs blender (KITCHEN AID™ brand employed). Add 11.84 grams total of a water solution comprised of 2.81 grams (8.19%) of the surfactant preparation from Example 1, 10.03 (29.21%) grams of the surfactant preparation from Example 2 and 21.49 grams (62.60%) of water (same prep as used in Example 3) followed by 5 minutes of mixing at #2 speed using the flat beater attachment. Add 30.0 grams of Min-U-Gel G-35 followed by 5 minutes of mixing which results in thick but pourable asphalt mastic. Add 10.1 grams of GC-66 fibers and mix another 5 minutes before adding 50 grams of asphalt cutback followed by 5 minutes of mixing to finish the batch. The finished batch was viscous, very slightly pourable asphalt mastic.

Empirical Test Results from Experiments:

Viscosity measured using a Brookfield LVT (E spindle) on a helipath stand at 0.6 rpm Measurements at elapsed time as indicated

| Exp. # | 2 hr. | 24 hr. | 7 day |
|---|---|---|---|
| 5 | 518,700 | 205,140 | 340,500 |
| 6 | 290,235 | 314,000 | 303,400 |
| 7 | 449,280 | 185,640 | 309,660 |

In the case of experiments 5 and 7 where the active chemical surfactant employed in the composition is the same and is used at the same percentage, the viscosity after both the initial and 7 day time periods is higher in the case of the formulation containing the surfactant-treated cellulose fibers. In the case of experiment 6 where a different chemical surfactant is employed as the pretreatment agent on the cellulose the initial and final viscosities are strong and considerably uniform over the 7 day period of time—a phenomenon indicative of the development of a robust and durable gel structure.

In light of the foregoing, it should be appreciated that the present invention significantly advances the art by providing a surfactant-treated cellulose fiber useful in asphalt cements and coatings. While particular embodiments of the invention have been disclosed in detail herein, it should be appreciated that the invention is not limited thereto or thereby inasmuch as variations on the invention herein will be readily appreciated by those of ordinary skill in the art. The scope of the invention shall be appreciated from the claims that follow.

I claim:

1. Surfactant-treated cellulose fibers comprising:
cellulose fibers; and
a clay surfactant incorporated into or on said cellulose fibers or both, wherein said clay surfactant is a surfactant that reduces the interfacial tension between asphalt clay and asphalt.

2. The fibers of claim 1 wherein said cellulose fibers used are produced by the deconstruction of paper products intended for recycling including newspapers and magazines.

3. The fibers of claim 1 wherein the cellulose fibers are produced by virgin production from wood pulp.

4. The fibers of claim 1 wherein the clay surfactant is selected from the group consisting of fatty amines and the organic and mineral acid salts thereof, alkyloxyalkylamines and the organic and mineral acid salts thereof, quaternary ammonium compounds, and mixtures of the forgoing.

5. The fibers of claim 4, wherein the clay surfactant is a fatty amine at least partially neutralized by organic acids.

6. The fibers of claim 4, wherein the clay surfactant is a fatty amine at least partially neutralized by mineral acids.

7. The fibers of claim 1, wherein the surfactant-treated cellulose fibers include from 65 to 90% cellulose fiber and from 10 to 35% of a clay surfactant by weight.

8. An asphalt composition comprising the surfactant-treated cellulose fibers of claim 1.

9. The asphalt composition of claim 8 further comprising asphalt clay.

10. The asphalt composition of claim 9 wherein said asphalt clay is Attapulgite clay.

11. A method for producing an asphalt composition comprising the steps of:
adding surfactant-treated cellulose fibers to asphalt, wherein said surfactant-treated cellulose fibers include:
cellulose fibers, and
a clay surfactant incorporated into or on said cellulose fibers, wherein said clay surfactant is a surfactant that reduces the interfacial tension between asphalt clay and asphalt; and thereafter
adding an asphalt composition addition selected from inert filler and asphalt clay.
